(19) United States
(12) Patent Application Publication
(10) Pub. No.: US 2021/0048596 A1
(43) Pub. Date: Feb. 18, 2021

(54) LENS MODULE AND LENS MOUNT

(71) Applicant: Newmax Technology Co., Ltd., Taichung City (TW)

(72) Inventor: Yung-Fu Liang, Taichung City (TW)

(21) Appl. No.: 16/542,810

(22) Filed: Aug. 16, 2019

(51) Int. Cl. G02B 7/02

(52) U.S. Cl. CPC G02B 7/022; G03B 17/12; G02B 7/023; G02B 7/026

(57) ABSTRACT

A lens module includes a lens mount, at least one lens, and a positioning ring. The lens mount is cylinder-shaped and has a first end and a second end along an axial direction. The inner peripheral face of the lens mount has a positioning section near the first end. The lens is arranged inside the lens mount. The positioning ring is arranged inside the lens mount, and an outer peripheral face thereof is positioned to the positioning section of the lens mount to prevent the lens from falling out. At least one of the positioning section and the outer peripheral face is formed with at least one threaded groove. The threaded groove extends around the axial direction. An end of the threaded groove near the first end is open for being injected with an adhesive for an engagement between the positioning ring and the lens mount.

### BACKGROUND OF THE INVENTION

### Field of the Invention

The present invention relates to a lens module and a lens mount.

### Description of the Prior Art

A lens module is usually composed of a lens mount and a plurality of lenses. The lens mount has plural stepped faces on the inner peripheral face for the lenses to abut against in order to make the positions of the lenses precise. A positioning ring fixed at an end of the lens mount having a larger inner diameter is often used to prevent the lens from falling for protection.

The positioning ring is usually positioned to the lens mount by tight-fitting or engaging structure. Patent TW 1616698 disclosed another means to position the positioning ring. The inner peripheral face of the lens mount is formed with plural grooves extending axially, and the grooves are injected with adhesive to fix the positioning ring.

However, the structure has at least two disadvantages. First, the adhesive may reach the other side of the positioning ring to contaminate the lenses. Second, the contact area between the positioning ring and the lens mount is reduced because of the grooves. When the adhesive deteriorates, the positioning ring may fall from the lens mount.

### SUMMARY OF THE INVENTION

The main object of the present invention is to provide a lens module and a lens mount for positioning the positioning ring on the lens mount tightly and to prevent the adhesive from reaching the lens.

To achieve the above and other objects, the lens module includes a lens mount, at least one lens, and a positioning ring.

The lens mount is cylinder-shaped and has an inner peripheral face. A receiving space is enclosed by the inner peripheral face. The lens mount has a first end and a second end along an axial direction. The inner peripheral face has a positioning section near the first end. The at least one lens is arranged in the receiving space. An outer peripheral face of the at least one lens contacts the inner peripheral face of the lens mount. The positioning ring is arranged in the receiving space. An outer peripheral face of the positioning ring is positioned to the positioning section of the lens mount to prevent the at least one lens from falling out from the first end of the lens mount. At least one of the positioning section and the outer peripheral face of the positioning ring is formed with at least one threaded groove. The at least one threaded groove extends around the axial direction of the lens mount. An end of the at least one threaded groove near the first end is open for being injected with an adhesive for an engagement between the outer peripheral face of the positioning ring and the inner peripheral face of the lens mount.

To achieve the above and other objects, the present invention also provides a lens mount. The lens mount is cylinder-shaped and has an inner peripheral face. A receiving space is enclosed by the inner peripheral face for receiving at least one optical element. The lens mount has a first end and a second end along an axial direction thereof. The inner peripheral face has a positioning section near the first end. The positioning section is adapted for an outer peripheral face of the at least one optical element to contact and connect. The positioning section has at least one threaded groove. The at least one threaded groove extends around the axial direction of the lens mount and is open at an end thereof near the first end of the lens mount. The at least one threaded groove is adapted for being injected with an adhesive for an engagement between the outer peripheral face of the at least one optical element and the inner peripheral face of the lens mount.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a lens mount and a positioning ring of the present invention;

FIG. 2 is a breakdown drawing showing a lens mount and a positioning ring of the present invention;

FIG. 3 is a breakdown drawing of the present invention;

FIG. 4 is a partial enlargement of FIG. 3;

FIG. 5 is a profile of the present invention;

FIG. 6 is a partial enlargement of FIG. 5;

FIG. 7 is an illustration showing adhesive injection of the present invention;

FIG. 8 is a stereogram showing a positioning ring of the present invention;

FIG. 9 is a stereogram showing a positioning ring in a second embodiment of the present invention;

FIG. 10 is a stereogram showing a positioning ring in a third embodiment of the present invention;

FIG. 11 is a stereogram showing a positioning ring in a fourth embodiment of the present invention;

FIG. 12 is a profile showing a third embodiment of the present invention;

FIG. 13 is a partial breakdown drawing of FIG. 12;

FIG. 14 is an illustration showing adhesive injection in a third embodiment of the present invention.

### DETAILED DESCRIPTION OF THE PREFERRED EMBODIMENTS

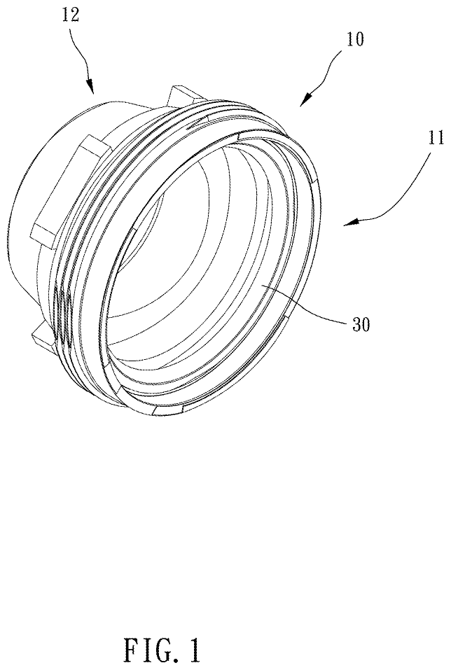

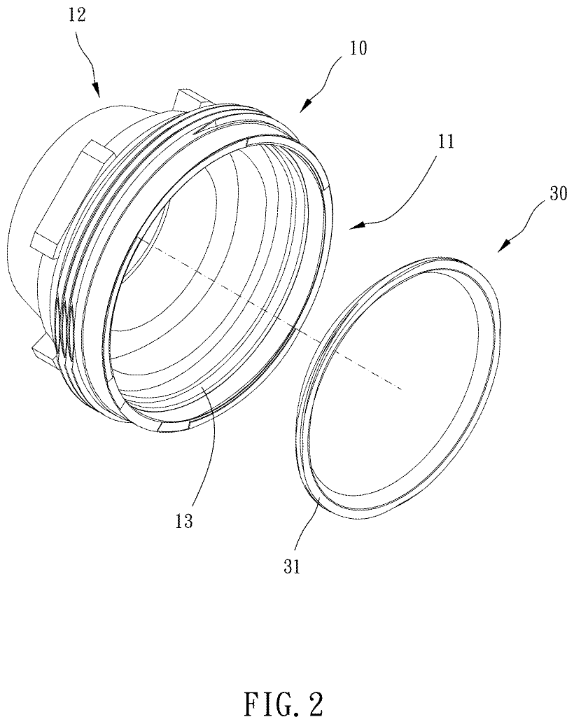

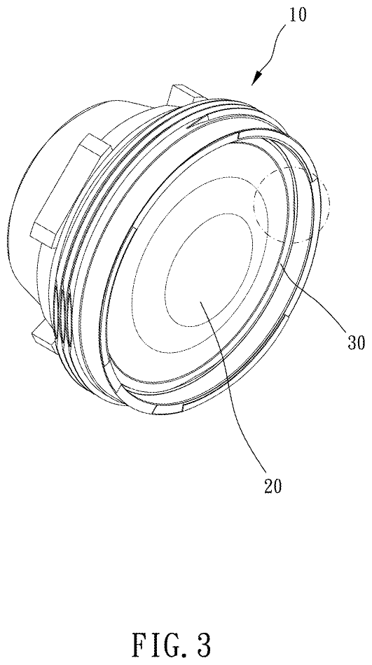

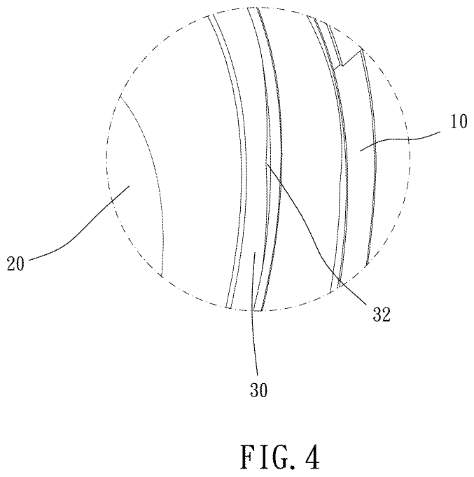

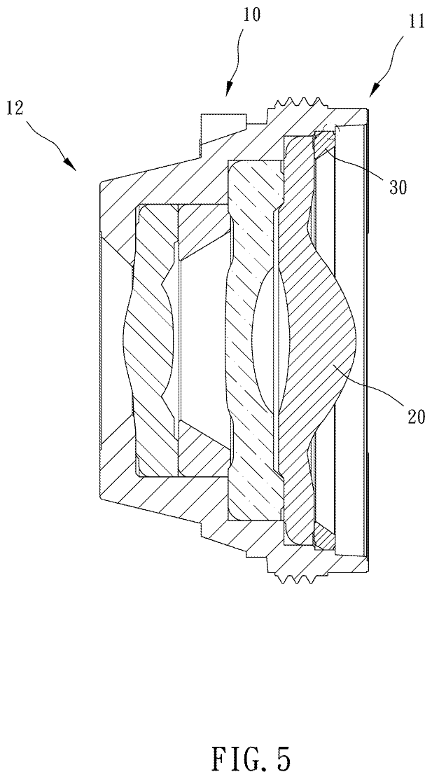

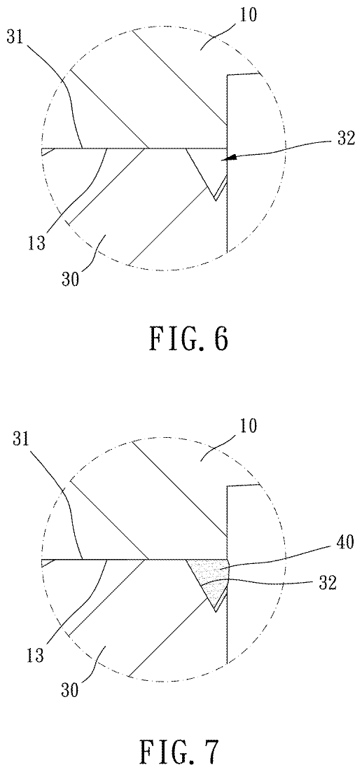

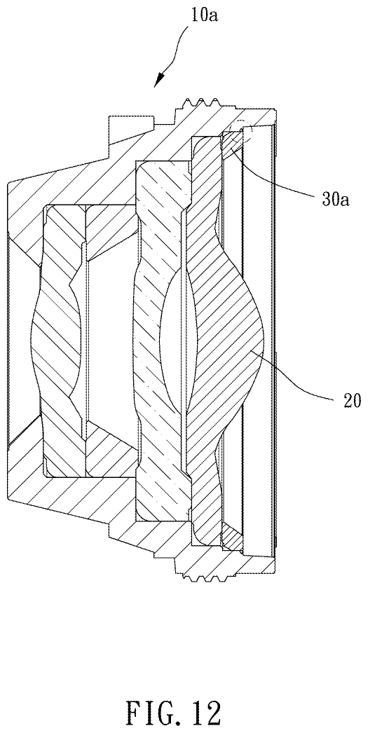

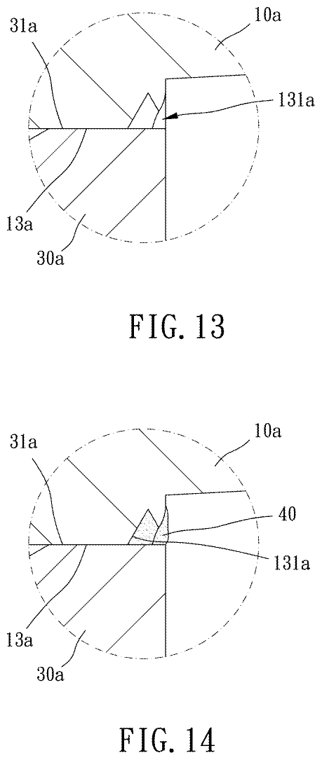

Please refer to FIG. 1 to FIG. 14, the lens module of the present invention includes a lens mount 10,10a,10b, at least one lens 20, and a positioning ring 30,30a.

The lens mount 10,10a,10b is cylinder-shaped and has an inner peripheral face. A receiving space is enclosed by the inner peripheral face. The lens mount 10,10a,10b has a first end 11 and a second end 12 along an axial direction. The inner peripheral face has a positioning section 13,13a,13b near the first end 11. The at least one lens 20 is arranged in the receiving space. An outer peripheral face of the at least one lens contacts the inner peripheral face of the lens mount 10,10a,10b. The positioning ring 30,30a is arranged in the receiving space. An outer peripheral face 31,31a of the positioning ring 30,30a is positioned to the positioning section 13,13a,13b of the lens mount 10,10a,10b to prevent the at least one lens 20 from falling out from the first end 11 of the lens mount 10,10a,10b. At least one of the positioning section 13,13a,13b and the outer peripheral face 31,31a of the positioning ring 30,30a is formed with at least one threaded groove 131a,131b,32,32a. The at least one threaded groove 131a,131b,32,32a extends around the axial direction of the lens mount 10,10a,10b. An end of the at least one threaded groove 131a,131b,32,32a near the first end 11 is open for being injected with an adhesive 40 for an engagement between the outer peripheral face 31,31a of the positioning ring 30,30a and the inner peripheral face of the lens mount 10,10a,10b.

The present invention also provides a lens mount 10a,10b. The lens mount 10a,10b is cylinder-shaped and has an inner peripheral face. A receiving space is enclosed by the inner peripheral face for receiving at least one optical element. The lens mount 10a,10b has a first end and a second end along an axial direction thereof. The inner peripheral face has a positioning section 13a,13b near the first end. The positioning section 13a,13b is adapted for an outer peripheral face of the at least one optical element to contact and connect. The positioning section 13a,13b has at least one threaded groove 131a,131b. The at least one threaded groove 131a,131b extends around the axial direction of the lens mount 10a,10b and is open at an end thereof near the first end of the lens mount 10a,10b. The at least one threaded groove 131a,131b is adapted for being injected with an adhesive 40 for an engagement between the outer peripheral face of the at least one optical element and the inner peripheral face of the lens mount 10a,10b.

Specifically, in the embodiments shown in the drawings, the at least one threaded groove 131a,131b,32,32a is formed only on one of the positioning section 13a,13b and the positioning ring 30,30a. However, in other possible embodiments, it is preferable that each of the positioning section and the positioning ring is formed with at least one said threaded groove.

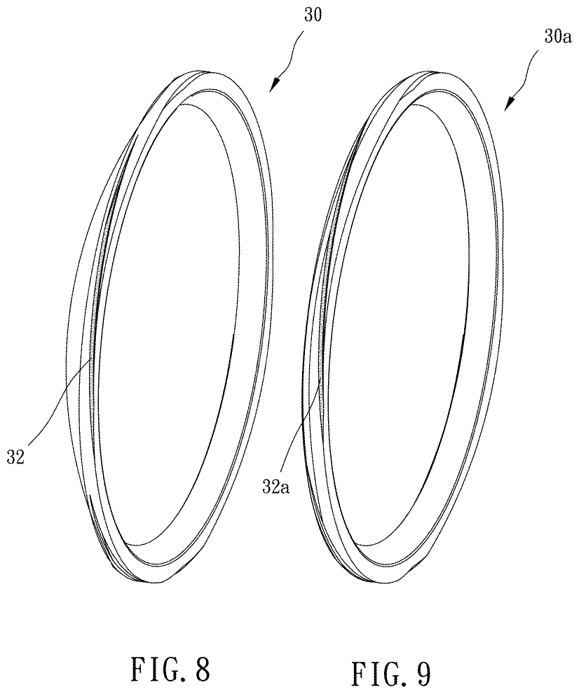

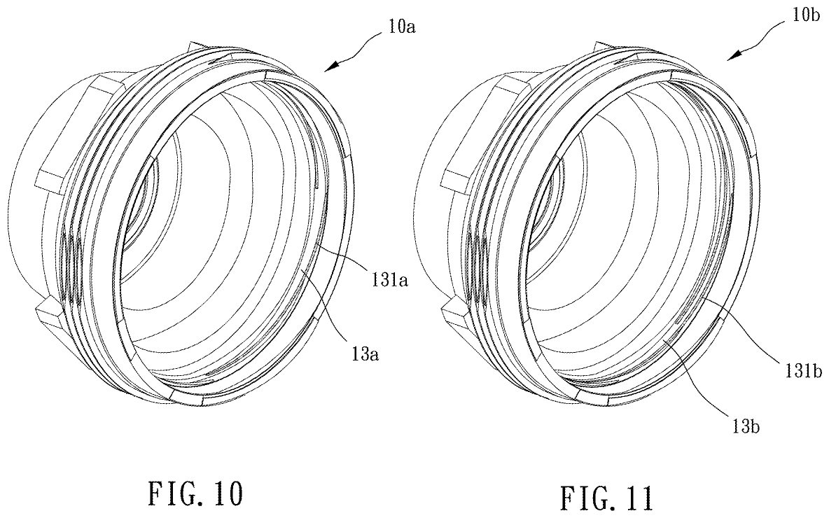

In the present embodiment, the at least threaded groove 32,131a along the axial direction of the lens mount 10,10a is smaller than a length of the outer peripheral face 31 of the positioning ring 30 along the axial direction of the lens mount 10,10a. That is, the at least one threaded groove 32,131a doesn't extend to an end of the positioning ring 30 near the second end 12. For example, a plurality of short threaded grooves are formed, as shown in FIG. 8 or FIG. 10. In other embodiments of the present invention, as shown in FIG. 9 or FIG. 11, the length of the at least threaded groove 32a,131b along the axial direction of the lens mount 10b is larger than or equal to the length of the outer peripheral face 31a of the positioning ring 30a along the axial direction of the lens mount 10b so that the at least one threaded groove 32a,131b communicates two opposite sides of the positioning ring 30a. For example, a single long threaded groove is formed. Specifically, though the at least one threaded groove extends to an end of the positioning ring near the lens, the adhesive barely flows to the lens due to the long threaded groove. Thus, the adhesive can be spread widely, and the adhesive is avoided from reaching the lens.

More specifically, the at least one threaded groove 131a,131b,32,32a has a radial cross-section which is triangle to have a sharp corner at a bottom thereof. Preferably, the at least threaded groove 131a,131b,32,32a has a radial depth ranged between 2 micrometers to 300 micrometers.

In use, the adhesive 40 can be injected into the at least one threaded groove 131a,131b,32,32a via the opening thereof near the first end 11 and flows toward the second end 12 along the at least one threaded groove 131a,131b,32,32a. During the adhesive 40 flowing, the adhesive 40 is going to solidified to prevent from contacting the lens.

In conclusion, the threaded groove of the present invention can be used to receive adhesive for engagement between the positioning ring and the lens mount. Because the threaded groove doesn't extend beside the lens or has a large length, the adhesive is hard to reach the lens. Thus, the lens may not be contaminated by the adhesive. Besides, the contact portion of the positioning ring and the lens mount has a threaded shape to provide friction so as to further enhance the engagement between the positioning ring and the lens mount.

What is claimed is:

1. A lens module, including:
a lens mount, being cylinder-shaped and having an inner peripheral face, a receiving space being enclosed by the inner peripheral face, the lens mount having a first end and a second end along an axial direction, the inner peripheral face having a positioning section near the first end;
at least one lens, arranged in the receiving space, an outer peripheral face of the at least one lens contacting the inner peripheral face of the lens mount;
a positioning ring, arranged in the receiving space, an outer peripheral face of the positioning ring being positioned to the positioning section of the lens mount to prevent the at least one lens from falling out from the first end of the lens mount;
wherein at least one of the positioning section and the outer peripheral face of the positioning ring is formed with at least one threaded groove, the at least one threaded groove extends around the axial direction of the lens mount, an end of the at least one threaded groove near the first end is open for being injected with an adhesive for an engagement between the outer peripheral face of the positioning ring and the inner peripheral face of the lens mount.

2. The lens module of claim 1, wherein a length of the at least threaded groove along the axial direction of the lens mount is smaller than a length of the outer peripheral face of the positioning ring along the axial direction of the lens mount.

3. The lens module of claim 1, wherein a length of the at least threaded groove along the axial direction of the lens mount is larger than or equal to a length of the outer peripheral face of the positioning ring along the axial direction of the lens mount so that the at least one threaded groove communicates two opposite sides of the positioning ring.

4. The lens module of claim 1, wherein the at least one threaded groove has a radial cross-section which is triangle to have a sharp corner at a bottom thereof.

5. The lens module of claim 1, wherein the at least threaded groove has a radial depth ranged between 2 micrometers to 300 micrometers.

6. A lens mount, being cylinder-shaped and having an inner peripheral face, a receiving space being enclosed by the inner peripheral face for receiving at least one optical element, the lens mount having a first end and a second end along an axial direction thereof, the inner peripheral face having a positioning section near the first end, the positioning section being adapted for an outer peripheral face of the at least one optical element to contact and connect, the positioning section having at least one threaded groove, the at least one threaded groove extending around the axial direction of the lens mount and being open at an end thereof near the first end of the lens mount, the at least one threaded groove being adapted for being injected with an adhesive for an engagement between the outer peripheral face of the at least one optical element and the inner peripheral face of the lens mount.

7. The lens mount of claim 6, wherein a length of the at least threaded groove along the axial direction of the lens mount is smaller than a length of the outer peripheral face of the at least one optical element along the axial direction of the lens mount.

8. The lens mount of claim 6, wherein a length of the at least threaded groove along the axial direction of the lens mount is larger than or equal to a length of the outer peripheral face of the at least one optical element along the axial direction of the lens mount so that the at least one threaded groove communicates two opposite sides of the at least one optical element.

9. The lens mount of claim 6, wherein the at least one threaded groove has a radial cross-section which is triangle to have a sharp corner at a bottom thereof.

10. The lens mount of claim 6, wherein the at least threaded groove has a radial depth ranged between 2 micrometers to 300 micrometers.
